(19) United States
(12) Patent Application Publication
(10) Pub. No.: US 2006/0223524 A1
(43) Pub. Date: Oct. 5, 2006

(54) Device, system and method of establishing a wireless communication link

(75) Inventor: Boris Ginzburg, Haifa (IL)

Correspondence Address: PEARL COHEN ZEDEK LATZER, LLP, 1500 BROADWAY, 12TH FLOOR, NEW YORK, NY, 10036, US

(73) Assignee: INTEL CORPORATION

(21) Appl. No.: 11/091,581

(22) Filed: Mar. 29, 2005

(51) Int. Cl. H04Q 7/20

(52) U.S. Cl. 455/424; 455/67.11; 370/338; 370/328

(57) ABSTRACT

Briefly, some embodiments of the invention provide devices, systems and methods of selectively establishing a wireless communication link. For example, a method in accordance with an embodiment of the invention may include selecting to transmit data either via a direct wireless communication link or via an indirect wireless communication link based on an efficiency-related criterion associated with said direct and indirect links.

### BACKGROUND OF THE INVENTION

In the field of wireless communications, a first wireless communication station may communicate with a second wireless communication station indirectly, for example, through a wireless access point. The Institute of Electrical and Electronics Engineers (IEEE) 802.11e standard provides a Direct Link Setup (DLS) which may be used for direct wireless communication between the first and second stations.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic block diagram illustration of a wireless communication system able to selectively establish a wireless communication link in accordance with an embodiment of the invention;

FIG. 2 is a schematic flow-chart of a method of selectively establishing a wireless communication link in accordance with an embodiment of the invention; and

FIG. 3 is a schematic block diagram illustration of a wireless communication station able to selectively establish a wireless communication link in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

It should be understood that embodiments of the invention may be used in a variety of applications. Although the invention is not limited in this respect, embodiments of the invention may be used in conjunction with many apparatuses, for example, a transmitter, a receiver, a transceiver, a transmitter-receiver, a wireless communication station, a wireless communication device, a wireless Access Point (AP), a modem, a wireless modem, a personal computer, a desktop computer, a mobile computer, a laptop computer, a notebook computer, a Personal Digital Assistant (PDA) device, a tablet computer, a server computer, a network, a Local Area Network (LAN), a Wireless LAN (WLAN), devices and/or networks operating in accordance with existing IEEE 802.11, 802.11a, 802.11b, 802.11e, 802.11g, 802.11i, 802.11n, 802.16 standards and/or future versions of the above standards, a Personal Area Network (PAN), a Wireless PAN (WPAN), units and/or devices which are part of the above WLAN and/or PAN and/or WPAN networks, one way and/or two-way radio communication systems, cellular radio-telephone communication systems, a cellular telephone, a wireless telephone, a Personal Communication Systems (PCS) device, a PDA device which incorporates a wireless communication device, or the like. It is noted that embodiments of the invention may be used in various other apparatuses, devices, systems and/or networks.

The term “data item” as used herein may include, for example, one or more packets, frames, blocks, bytes, bits, sequences of bytes or bits, strings, objects, files, or the like.

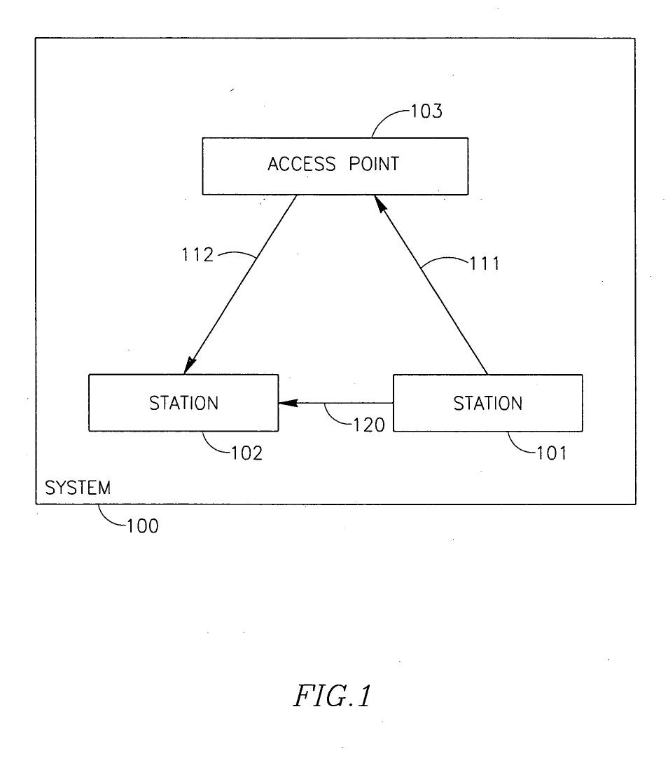

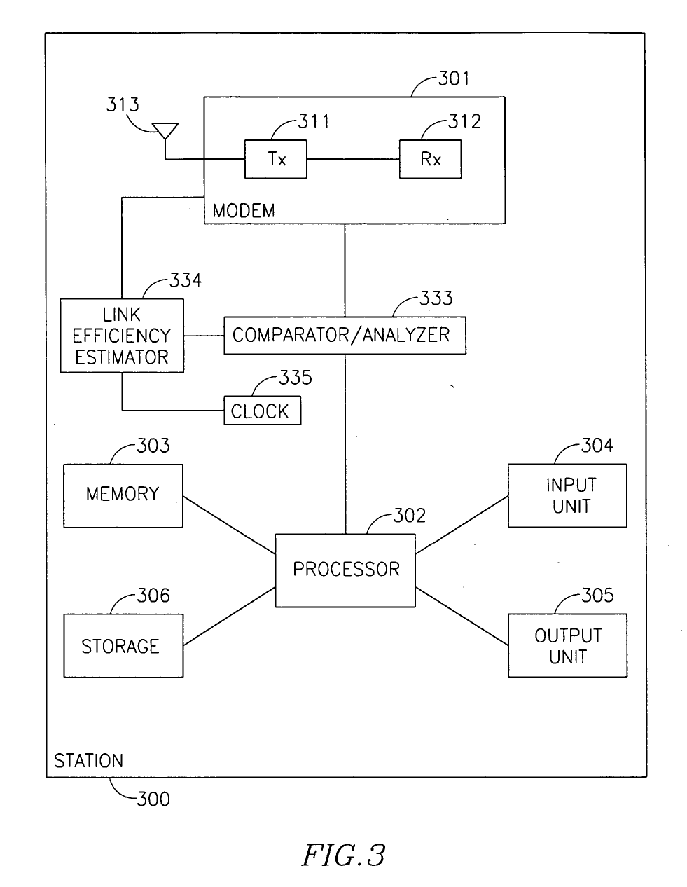

FIG. 1 schematically illustrates a block diagram of a wireless communication system 100 able to selectively establish a wireless communication link in accordance with an embodiment of the invention. System 100 may include, for example, one or more wireless communication stations, e.g., station 101 and 102, and one or more wireless access points, e.g., access point 103. Stations 101 and/or 102 may include, for example, a station similar to station 300 described below with reference to FIG. 3.

Station 101 may be able to communicate with station 102 directly via a wireless communication link 120, for example, in accordance with Direct Link Setup (DLS) of Institute of Electrical and Electronics Engineers (IEEE) 802.11e standard (“direct link”).

Station 101 may also be able to communicate with station 102 indirectly, for example, via access point 103 (“indirect link”). For example, station 101 may transmit data to access point 103 via a link 111, and access point 103 may transmit the data to station 102 via a link 112.

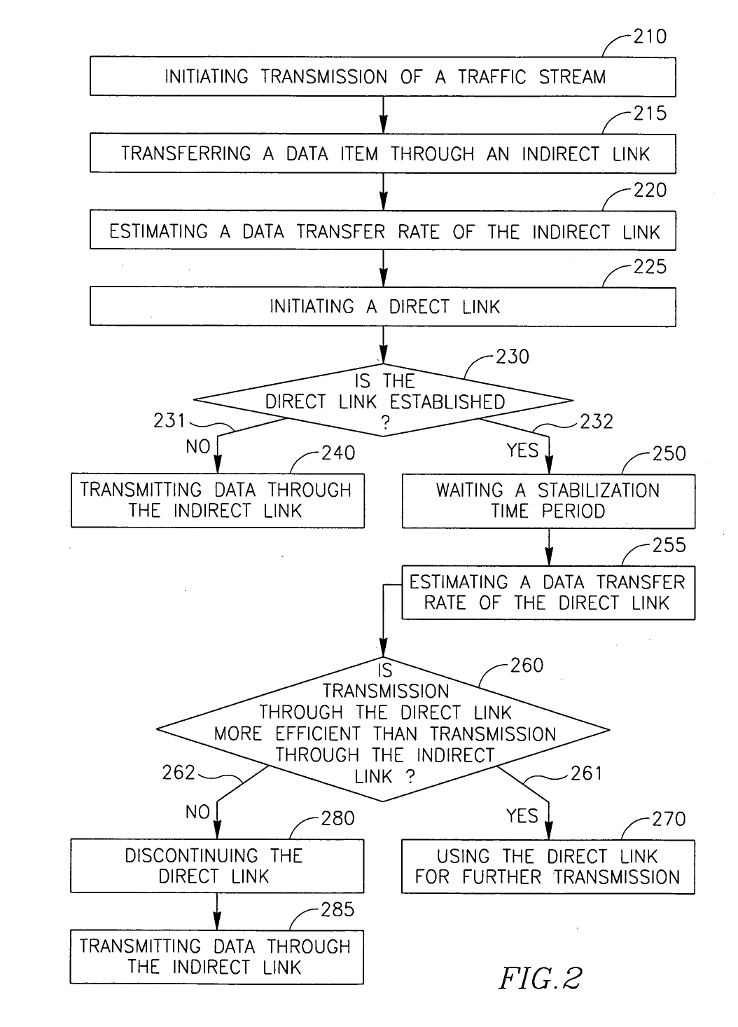

In accordance with some embodiments of the invention, station 101 may select to communicate with station 102 using the direct link or using the indirect link, depending on one or more criteria. For example, by performing an efficiency analysis (e.g., as described below with reference to FIG. 2), station 101 may determine that the direct link is more efficient then the indirect link, or vice versa, and may use the more efficient link for communication with station 102. In some embodiments, station 101 may select whether to transmit data via the direct link or via the indirect link based on an efficiency criterion or a transmission-related criterion associated with the direct and indirect links, for example, a criterion related to the efficiency of data transfer, e.g., data transfer rate or time required for transmission, of the direct and indirect links.

In some embodiments, for example, station 101 may select to use the direct link if the time required for transmitting a data item directly from station 101 to station 102 via the direct link 120, is shorter than the time required to transmit the data item indirectly, e.g., from station 101 to access point 103 via link 111 and then from access point 103 to station 102 via link 112.

In some embodiments, for example, station 101 may select to use the direct link if the data transfer rate associated with transmitting a data item directly from station 101 to station 102 via the direct link 120 is higher than the data transfer rate associated with transmitting the data item indirectly, e.g., from station 101 to access point 103 via link 111 and then from access point 103 to station 102 via link 112.

In some embodiments, for example, station 101 may select to use the direct link if the following inequality holds true:
1/R₀<(1/R₁)+(1/R₂) (1)
wherein R₀ denotes the data transfer rate via link 120, R₁ denotes the data transfer rate via link 111, and R₂ denotes the data transfer rate via link 112. Other suitable equations, calculations and/or conditions may be used in accordance with embodiments of the invention.

In some embodiments, for example, if the indirect link includes more than two segments, station 101 may compare between the inverse of a data transfer rate of the direct link and a sum of the inverses of data transfer rates of a plurality of segments of the indirect link.

Although portions of the discussion herein may relate, for exemplary purposes, to an indirect link having two segments, it will be appreciated that embodiments of the invention are not limited in this regard. In some embodiments, for example, an indirect link may include more than two segments, e.g., three segments, four segments, or the like.

Although portions of the discussion herein may relate, for exemplary purposes, to an indirect link to link a first station with a second station via an access point, embodiments of the invention are not limited in this regard. In some embodiments, for example, more than one access points may be used to establish an indirect link Additionally or alternatively, for example, a third station may be used to establish an indirect link between the first station and the second station. In yet another embodiment, a combination of one or more access points and/or one or more stations may be used to establish an indirect link between the first station and the second station.

Although portions of the discussion herein may relate, for exemplary purposes, to an efficiency-related criterion or parameter such as, for example, data transfer rate, inverse of data transfer rate, or transmission time, embodiments of the invention are not limited in this regard. In some embodiments, for example, other suitable data or parameters may be used, e.g., channel airtime data or parameters, power consumption data or parameters, or the like.

FIG. 2 is a schematic flow-chart of a method of selectively establishing a wireless communication link in accordance with an embodiment of the invention. Operations of the method may be implemented, for example, by system 100 of FIG. 1, by station 101 of FIG. 1, by station 102 of FIG. 1, by station 300 of FIG. 3, by modem 301 of FIG. 3, by processor 302 of FIG. 3, and/or by other suitable stations, access points, controllers, modems, processors, units, devices, and/or systems.

As indicated at box 210, the method may include, for example, initiating transmission of a traffic stream from a first station to a second station. As indicated at box 215, the method may include, for example, transferring a data item from the first station to the second station via an indirect link for a first time period. This may include, for example, transmitting the data item from the first station to an access point, and then transmitting the data item from the access point to the second station. The length of the first time period may be, for example, approximately 200 milliseconds, approximately 250 milliseconds, approximately 300 milliseconds, or any other suitable value.

As indicated at box 220, the method may include, for example, estimating first and second data transfer rates associated with transmission of data via first and second respective segments of the indirect link. This may include, for example, estimating a first data transfer rate, R₁, associated with transmission of the data item via the first segment of the indirect link, e.g., from the first station to the access point, and estimating a second data transfer rate, R₂, associated with transmission of the data item via the second segment of the indirect link, e.g., from the access point to the second station. In one embodiment, for example, estimating a data transfer rate may include, for example, dividing the size of a transferred data item (e.g., in bytes) by the time required for the transfer (e.g., in seconds).

As indicated at box 225, the method may include, for example, initiating a direct link, e.g., between the first and second stations. As indicated at box 230, the method may include, for example, determining whether the direct link is established For example, as indicated by arrow 231, the method may determine that the direct link is not established, e.g., if the first station and/or the second station do not support a direct link connection, if a direct link is unavailable due to poor transmission/reception conditions or due to a large distance between the first and second stations. In such case, as indicated at box 240, the method may include, for example, transmitting data from the first station to the second station via the indirect link. Alternatively, as indicated by arrow 232, if it is determined that the direct link is established, then the method may proceed with the operations of box 250 and onward.

As indicated at box 250, the method may optionally include, for example, waiting a second time period, e.g., to allow stabilization of the data transfer rate associated with transmission of data from the first station to the second station via the direct link. The second time period may be equal to, for example, approximately 200 milliseconds, approximately 250 milliseconds, approximately 300 milliseconds, or other suitable values.

As indicated at box 255, the method may include, for example, estimating a data transfer rate, R₀, associated with transmission of data from the first station to the second station via the direct link. In one embodiment, for example, estimating the data transfer rate may include, for example, dividing the size of a transferred data packet (e.g., in bytes) by the period of time required for the transfer (e.g., in seconds).

As indicated at box 260, the method may include, for example, determining whether transmission of data via the direct link is more or less efficient than transmission of data via the indirect link. This may be done, for example, using a suitable calculation or comparison. In one embodiment, for example, if Inequality 1 holds true, then the direct link may be deemed more efficient and the determination result may be positive. Conversely, if Inequality 1 does not hold, then the direct link may be deemed less efficient and the determination result may be negative.

As indicated by arrow 261, if the determination result is positive, then, as indicated at box 270, the method may include, for example, selecting to use the direct link for further transmission of data from the first station to the second station.

Conversely, as indicated by arrow 262, if the determination result is negative, the method may include, for example, disconnecting or discontinuing the direct link (box 280), e.g., using a teardown operation, and transmitting data from the first station to the second station via the indirect link (box 285). Other suitable operations may be performed based on the negative determination result, for example, generating a flag or indicator to avoid establishment or use of the direct link for at least a pre-defined period of time (e.g., approximately one minute, approximately five minutes, or the like).

Other suitable operations or sets of operations may be used in accordance with embodiments of the invention.

FIG. 3 schematically illustrates a block diagram of a wireless communication station able to selectively establish a wireless communication link in accordance with some embodiments of the invention. Station 300 may be an example of station 101 and/or station 102.

Station 300 may include, for example, a modem 301, a processor 302, a memory unit 303, an input unit 304, an output unit 305, and a storage unit 306. Station 300 may further include other suitable hardware components and/or software components.

Processor 302 may include, for example, a Central Processing Unit (CPU), a Digital Signal Processor (DSP), a microprocessor, a controller, a chip, a microchip, an Integrated Circuit (IC), or any other suitable multi-purpose or specific processor or controller.

Input unit 304 may include, for example, a keyboard, a mouse, a touch-pad, or other suitable pointing device or input device. Output unit 305 may include, for example, a Cathode Ray Tube (CRT) monitor, a Liquid Crystal Display (LCD) monitor, or other suitable monitor or display unit.

Memory unit 303 may include, for example, a Random Access Memory (RAM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, or other suitable memory units or storage units.

Storage unit 306 may include, for example, a hard disk drive, a floppy disk drive, a Compact Disk (CD) drive, a CD-ROM drive, or other suitable removable or non-removable storage units.

Modem 301 may include, for example, a wireless modem having, for example, a wireless transmitter 311, a wireless receiver 312, and an antenna 313. Transmitter 311 may include, for example, a Radio Frequency (RF) transmitter able to transmit RF signals. Receiver 312 may include, for example, a RF receiver able to receive RF signals. In some embodiments, transmitter 311 and receiver 312 may be implemented as a transceiver, a transmitter-receiver, or one or more units able to perform separate or integrated functions of sending and/or receiving wireless communication signals, blocks, frames, transmission streams, packets, messages and/or data.

Antenna 313 may include an internal and/or external RF antenna. In some embodiments, for example, antenna 313 may include a dipole antenna, a monopole antenna, an omni-directional antenna, an end fed antenna, a circularly polarized antenna, a micro-strip antenna, a diversity antenna, or any other type of antenna suitable for sending and/or receiving wireless communication signals, blocks, frames, transmission streams, packets, messages and/or data

In accordance with some embodiments of the invention, station 300 may selectively establish and use a direct or indirect wireless communication link, e.g., as described above, based on predetermined criteria, for example, a comparison or analysis of a transmission-related property of the direct and indirect links. Such comparison may be performed, for example, by a comparator/analyzer 333. The comparator/analyzer 333 may be implemented, for example, as part of modem 301, as part of processor 302, as a dedicated controller, as a dedicated hardware component or software component, or as a software application, e.g., a communication software, a communication driver, an Operating System, or the like. In some embodiments, the comparator/analyzer 333 may select whether to transmit data via a direct link or an indirect link based on an efficiency criterion or a transmission-related criterion associated with the direct and indirect links, e.g., an efficiency criterion related to data transfer rate or transmission time.

In some embodiments, station 300 may optionally include one or more units or sub-units which may provide to the comparator/analyzer 333 data for comparison or analysis by the comparator/analyzer 333. For example, in one embodiment, station 300 may optionally include a link efficiency estimator 334, which may be implemented, for example, as part of modem 301, as part of processor 302, as part of the comparator/analyzer 333, as a dedicated controller, as a dedicated hardware component or software component, or as a software application, e.g., a communication software, a communication driver, an Operating System, or the like.

In some embodiments, the link efficiency estimator 334 may, for example, measure the time required for transmission of a data item by station 300 via a direct link, and may measure the time required for transmission of the data item by station 300 via an indirect link. The time measurement may be performed by the link efficiency estimator 334, for example, using clock data (e.g., using a clock of processor 302 or a clock 335); for example, the link efficiency estimator 334 may record the time at which a transmission begins and the time at which the same transmission ends (e.g., the time an acknowledgment message is received by station 300 in response to the transmission), and determine the difference between the two recorded values as the transmission time. In some embodiments, the link efficiency estimator 334 may divide the size (e.g., in bytes) of the transmitted data item by the transmission time (e.g., in seconds), thereby to determine a data transfer rate.

The link efficiency estimator 334 may, for example, calculate a first transmission time and/or a first data transfer rate, associated with a transmission by station 300 via an indirect link, and may calculate a second transmission time and/or a second data transfer rate, associated with a transmission by station 300 via a direct link The link efficiency estimator 334 may provide the first and second transmission times, and/or the first and second data transfer rates, to the comparator/analyzer 333.

The comparator/analyzer 333 may compare a first value (e.g., the first transmission time or data transfer rate), received from the link efficiency estimator 334 and associated with transmission via the indirect link, with a second value received from the link efficiency estimator 334 (e.g., the second transmission time or data transfer rate) associated with transmission via the direct link. By comparing or otherwise analyzing the first and second received values, which may relate to the transmission efficiency through the respective indirect and direct links, comparator/analyzer 333 may enable station 300 to select to transmit further data via the more efficient of the direct link or the indirect link.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

Some embodiments of the invention may be implemented, for example, using a machine-readable medium or article which may store an instruction or a set of instructions that, if executed by a machine, for example, by station 101, by station 102, by station 300, by modem 301, by processor 302, by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit (e.g., memory unit 303 or storage unit 306), memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method comprising:
selecting to transmit data either via a direct wireless communication link or via an indirect wireless communication link based on an efficiency-related criterion associated with said direct and indirect links.

2. The method of claim 1, comprising:
estimating a first value of an efficiency-related parameter associated with said direct link;
estimating a second value of said efficiency-related parameter associated with said indirect link; and
comparing between said first value and said second value.

3. The method of claim 2, wherein comparing comprises:
comparing between a data transfer rate of said direct link and a data transfer rate of said indirect link.

4. The method of claim 2, wherein comparing comprises:
comparing between the inverse of a data transfer rate of said direct link and a sum of the inverses of data transfer rates of a plurality of segments of said indirect link.

5. The method of claim 2, wherein comparing comprises:
comparing between the time required for transmitting a data item through said direct link and the time required for transmitting said data item through said indirect link.

6. The method of claim 1, further comprising:
transmitting data through the link selected by said selecting.

7. The method of claim 1, further comprising:
disconnecting the direct link if the indirect link is selected by said selecting.

8. An apparatus comprising:
a processor to select to transmit data either via a direct wireless communication link or via an indirect wireless communication link based on an efficiency-related criterion associated with said direct and indirect links.

9. The apparatus of claim 8, comprising:
an estimator to estimate a first value of an efficiency-related parameter associated with said direct link, and a second value of said efficiency-related parameter associated with said indirect link.

10. The apparatus of claim 9, further comprising:
a comparator to compare between said first value and said second value.

11. The apparatus of claim 10, wherein said efficiency-related parameter comprises data transfer rate.

12. The apparatus of claim 10, wherein the comparator is to compare between the inverse of a data transfer rate of said direct link and a sum of the inverses of data transfer rates of a plurality of segments of said indirect link.

13. The apparatus of claim 10, wherein the comparator is to compare between the time required for transmitting a data item through said direct link and the time required for transmitting said data item through said indirect link.

14. The apparatus of claim 8, further comprising:
a transmitter to transmit data via the link selected by said processor.

15. The apparatus of claim 8, wherein the processor is to disconnect the direct link if the indirect link is selected by said processor.

16. The apparatus of claim 10, comprising a wireless modem operatively associated with an antenna to send and receive signals carrying said data.

17. A wireless communication system comprising:
a first wireless communication station to transmit data; and
a second wireless communication station to receive said data,
wherein said first station comprises a processor to select to transmit said data either via a direct wireless communication link or via an indirect wireless communication link based on an efficiency-related criterion associated with said direct and indirect links.

18. The wireless communication system of claim 17, wherein said first station comprises an estimator to estimate a first value of an efficiency-related parameter associated with said direct link, and a second value of said efficiency-related parameter associated with said indirect link

19. The wireless communication system of claim 18, wherein said first station comprises a comparator to compare between said first value and said second value.

20. A machine-readable medium having stored thereon a set of instructions that, if executed by a machine, cause the machine to perform a method comprising:
selecting to transmit data either via a direct wireless communication link or via an indirect wireless communication link based on an efficiency-related criterion associated with said direct and indirect links.

21. The machine-readable medium of claim 20, wherein the set of instructions, if executed by a machine, result in:
estimating a first value of an efficiency-related parameter associated with said direct link;
estimating a second value of said efficiency-related parameter associated with said indirect link; and
comparing between said first value and said second value.

22. The machine-readable medium of claim 21, wherein the set of instructions, if executed by a machine, result in:
transmitting data through the link selected by said selecting.
